(19) United States
(12) Patent Application Publication
(10) Pub. No.: US 2010/0017303 A1
(43) Pub. Date: Jan. 21, 2010

(54) DescripWriter, A process for providing sellers at online auctions, classifieds, and other e-commerce sites a pre-written item title and description with some interactive adjustable variables resulting in an effective and thorough identification of the specific product or service they are selling

(76) Inventor: Robert King, Casa Grande, AZ (US)

Correspondence Address: KEITH L. JENKINS, 2222 NORTH MCQUEEN ROAD #2069, CHANDLER, AZ, 85225, US

(21) Appl. No.: 12/173,822

(22) Filed: Jul. 16, 2008

(51) Int. Cl. G06Q 30/00

(52) U.S. Cl. 705/27

(57) ABSTRACT

DescripWriter, A process for providing sellers at online auctions, classifieds, and other e-commerce sites a pre-written item title and description with the steps of: A database composed of pre-written titles and descriptions, A specific different title and description for each kind of product or service within that database, A method for the user to access this database of pre-written titles and descriptions by use of their computer, An interactive working environment on either a website or within a software program that allows the user to select, adjust, and/or modify the data with optional variables within the title and description, A method for the user to place the finished title and description within the so designated areas of an online e-commerce site.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of Internet-related business method and more specifically to a process for providing sellers at online auctions, classifieds, and other e-commerce sites a pre-written item title and description with some interactive adjustable variables resulting in an effective and thorough identification of the specific product or service they are selling.

With the rise of online auction sites, classified sites, and other e-commerce sites on the Internet over the last 10+ years, there has been a growing population of individuals using these types of sites to sell their products or services. This has consisted of requiring the seller to write their own title and description without any type of help in the composition of these listings.

The current process today is that the seller on these sites is given an area in which to type their title and description of the product or service. Though the technology has advanced to the point of helping the seller with the look and format of a listing through help tools on websites or in software, they still have not provided any help in drafting the title and description of the item being sold.

There currently exists a variety of software programs and websites that assist the seller in designing and providing an attractive layout of their auction listing, but this is strictly related to look and formatting. They do not provide any help in composing or writing the actual title and description. Some sites actually encourage the seller to select specifics about their item from drop down menus (size, color, etc.) but only for the purpose of sorting the auction listing for potential buyers looking for those specifics, and they do not effect the title and description itself which the seller must write completely by themselves.

With the current requirement for sellers to write their own titles and descriptions on online auctions, classified sites, and other e-commerce sites, the result has been a mixture of listings that are poorly written, inaccurately described, and/or lacking crucial information. This has been the cause of confusion between the seller and the buyer in many cases about what is being sold. It has also limited the effectiveness of their listing to their knowledge of grammar, marketing and/or the product specifics. Often, the seller is lacking in one or all of these areas, resulting in a reduction of sales and/or a reduction of buyers.

The process in the patent will change all that and allow any seller to prepare a thorough and complete title and description in an effective manner that will reducing confusion about what is being sold, provide all the crucial elements of the product or service, and present it in a way that actually markets the product or service to potential buyers.

### BRIEF SUMMARY OF THE INVENTION

The primary object of the invention is to provide a pre-written title and description of a product or service for sale on an e-commerce site such as an auction or classified site rather than requiring the seller to compose it.

Another object of the invention is to provide the seller with the essential elements needed in a title and description of their product or service to accurately describe it to a potential buyer on an e-commerce site.

Another object of the invention is to provide the seller with interactive variable selections of these essential elements to ensure that it conforms to their specific product or service.

A further object of the invention is to assist the seller by offering interactive variable selections of adjectives and adverbs to better promote their product or service in the title and description.

Yet another object of the invention is to provide a method that reduces the time necessary for a seller to compose a listing for his product or service.

Still yet another object of the invention is to provide a method that encourages seller confidence that an accurate and through title and description are being prepared.

Another object of the invention is to provide a tool that enables the seller to write a more effective and thorough listing for their product and service in order to increase sales.

Another object of the invention is to provide a seller tool that increases utilization and/or membership of the site or software using the process.

A further object of the invention is to provide a seller tool that decreases problems between sellers and buyers by providing all the critical data about the product or service so their is less confusion about what is being sold.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for providing sellers at online auctions, classifieds, and other e-commerce sites a pre-written item title and description comprising the steps of: A database composed of pre-written titles and descriptions, A specific different title and description for each kind of product or service within that database, A means for the user to access this database of pre-written titles and descriptions by use of their computer, An interactive working environment on either a website or within a software program that allows the user to select, adjust, and/or modify the data within the title and description, A means for the user to place the finished title and description within the so designated areas of an online e-commerce site.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan view of the method, phase 1, showing DescripWriter dormant to left of title and description fields on a webpage.

FIG. 2 is a plan view of the method, phase 2, showing pop-up interactive screen of DescripWriter.

FIG. 3 is a plan view of the method, phase 3, showing finished description placed in the description area of the webpage.

FIG. 4 is a flow chart of the operations that comprise the method.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

This business method which we have termed as the DescripWriter assists sellers of products and services on online auction sites, classified sites, and other e-commerce selling sites who may lack writing, composition and/or marketing skills, by providing a prewritten title and/or item description containing all the necessary components for a successful listing. Rather than having to write their own title or description that is the current method on all auctions and classified sites, the user can now use a prewritten title and description, saving them valuable time and giving them a polished description that will improve the results on their listing.

In addition to the prewritten item and descriptions, the DescripWriter will include an interactive element that allows the seller to change the specifics of the prewritten title and description in its initial preparation by providing them with choices for certain adjectives, adverbs and specifics with drop-down selection or empty text boxes. After the title and description is accepted, it will then allow them to edit them manually from the text populated areas if they desire more changes.

Other online auction, classified sites, and selling sites require the seller to write their own title and description, but this will be substantial improvement to all of these types of sites in the future. It can also be the basis for a software program that can be used to prepare titles and descriptions for multiple sites.

The DescripWriter can be used by a seller to provide them with a prewritten title and description in their auction, classified ad, or other online selling listing. The DescripWriter and its features can be either embedded directly into the listing portion of the website as a feature provided by the website or it can be utilized in a software format that is provided to sellers to use at websites of their choice or software specified websites.

The steps for using this business method comprise the following steps:

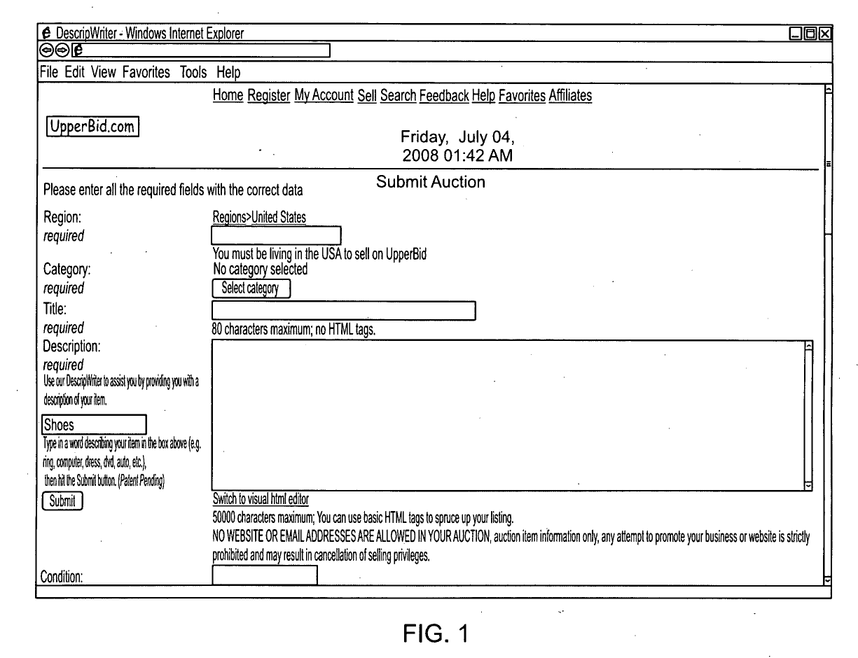

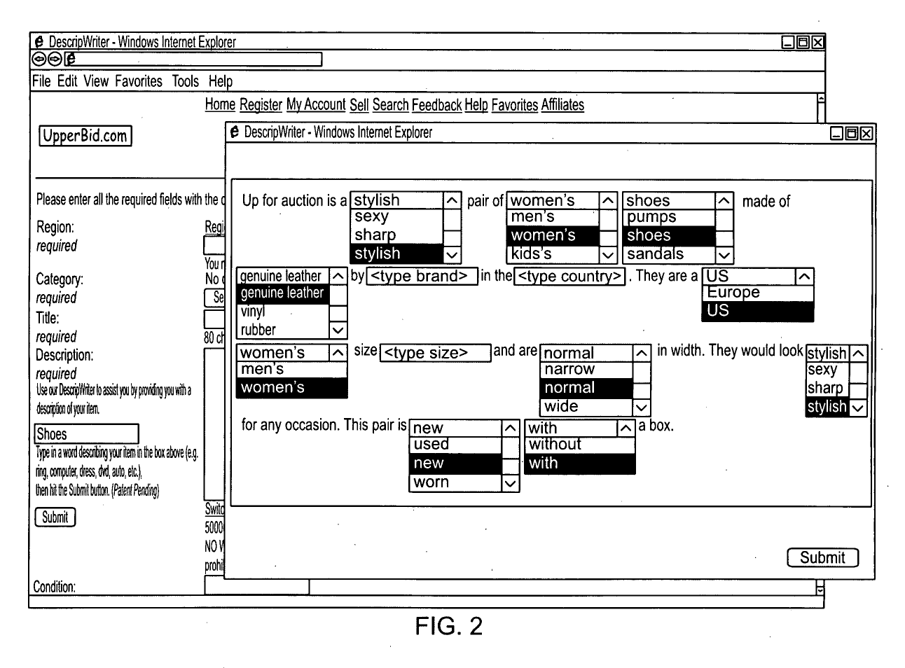

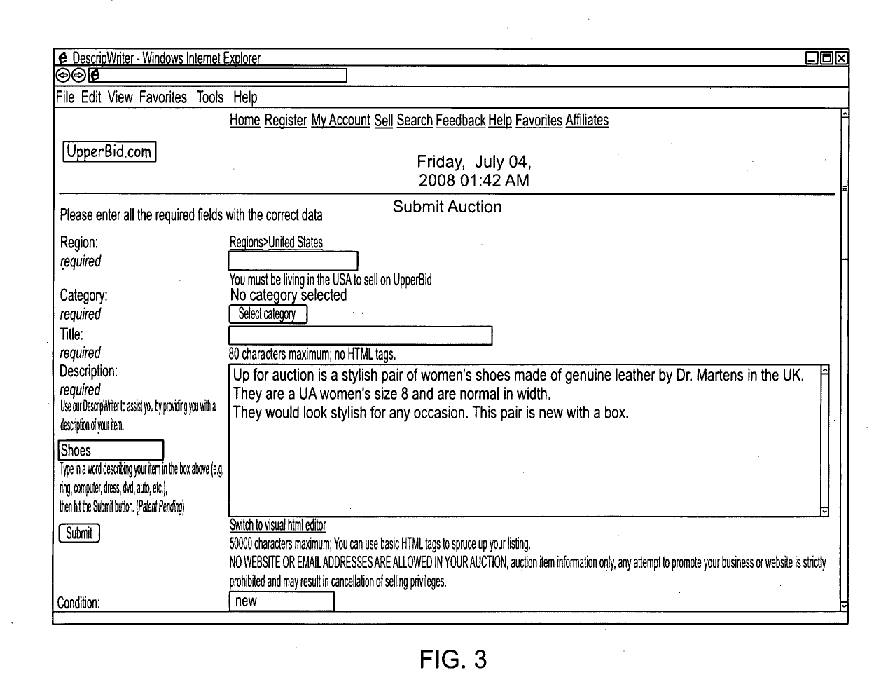

Turning first to FIG. 1, there is a standard auction listing webpage, with the place for the seller to write a title and a description. To the of the description box there is the business method termed DescripWriter with a text box for typing in the type of item (i.e. shoe on figure). This is where the seller enters their type of item and hits the submit button underneath which produces a pop-up box shown in FIG. 2. To accomplish an important function of the business method, there is shown in FIG. 2 the pop-up box with the pre-written description. This description includes interactive elements where the seller can make a choice for the variables of the item and adjective or adverb descriptive words, which are shown in FIG. 2 with either the drop down menus (e.g. stylish, sexy, sharp) or the text boxes (e.g. type size). The black highlighted words are the supposed choices of a seller that will be selected for insertion into the actual description field. Once the seller has completed the selection process, they will then hit the submit button which will then result in what is shown in FIG. 3

The completed process can be shown in FIG. 3, in which the selected text has now been placed into the description field on the webpage of the auction site. The seller then has the option to manually fix or change anything they want to with the description within the populated area.

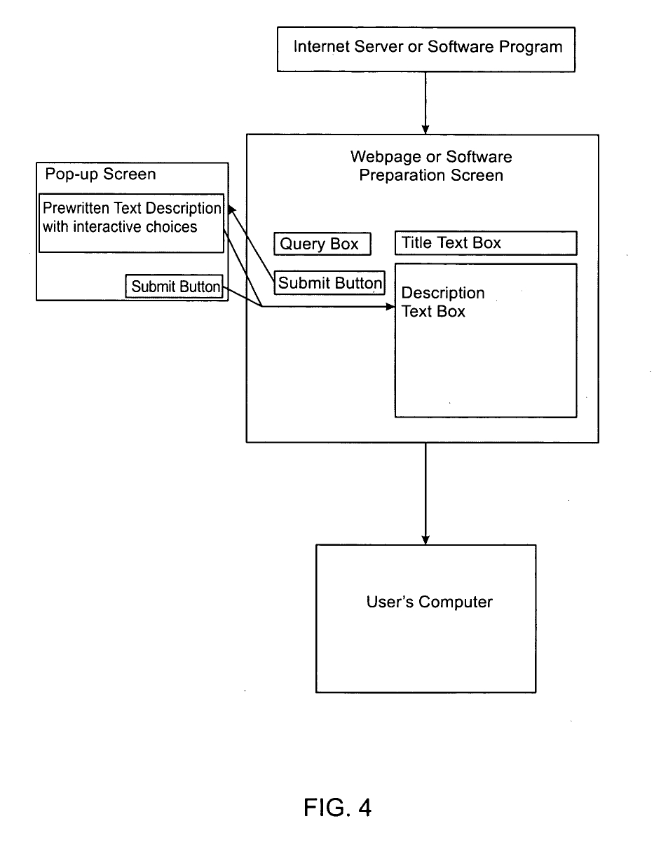

The entire business method process of the DescripWriter is shown in the flow chart labeled FIG. 4, which shows that the process begins with either a software program or an Internet server which contains the original database. The User interacts with that database by means of webpage or software screen.

What is claimed is:

1. A process for providing sellers at online auctions, classifieds, and other e-commerce sites a pre-written item title and description comprising the steps of:
A database composed of pre-written titles and descriptions;
A specific different title and description for each kind of product or service within that database;
A means for the user to access this database of pre-written titles and descriptions by use of their computer;
An interactive working environment on either a website or within a software program that allows the user to select, adjust, and/or modify the data within the title and description;
A means for the user to place the finished title and description within the so designated areas of an online e-commerce site.

2. A process as described in 1 which includes some interactive adjustable variables resulting in an effective and thorough identification of the specific product or service they are selling comprising the steps of:
Interactive elements of the provided title and description that allow the user to adjust the variables of their product or service;
and Interactive elements of the provided title and description that allow the user to adjust the descriptive adjectives and adverbs within the title and description.
